(19) United States
(12) Patent Application Publication
(10) Pub. No.: US 2014/0282220 A1
(43) Pub. Date: Sep. 18, 2014

(54) PRESENTING OBJECT MODELS IN AUGMENTED REALITY IMAGES

(71) Applicants: Tim Wantland, Bellevue, WA (US); Christian Colando, Seattle, WA (US); Shane Landry, Woodinville, WA (US)

(72) Inventors: Tim Wantland, Bellevue, WA (US); Christian Colando, Seattle, WA (US); Shane Landry, Woodinville, WA (US)

(21) Appl. No.: 13/830,029

(22) Filed: Mar. 14, 2013

(51) Int. Cl. G06F 3/0484

(52) U.S. Cl. CPC G06F 3/04845
USPC 715/782

(57) ABSTRACT

Embodiments are disclosed herein that relate to displaying information from search results and other sets of information as augmented reality images. For example, one disclosed embodiment provides a method of presenting information via a computing device comprising a camera and a display. The method includes displaying a representation of each of one or more items of information of a set of electronically accessible items of information. The method further comprises receiving a user input requesting display of a selected item of the set of electronically accessible items of information, obtaining an image of a physical scene, and displaying the image of the physical scene and the selected item together on the display as an augmented reality image.

### BACKGROUND

Various types of information may be contained in a set of computer-readable information. Examples of types of information include, but are not limited to documents (e.g. word processing documents, PDF documents), images, drawings, and spreadsheets. Different types of information within a set of information may be presented in different manners when selected for viewing. For example, in the case of a set of Internet search results, image results may be presented in a browser application, while document results may be presented within a document viewing and/or authoring application.

### SUMMARY

Embodiments are disclosed herein that relate to displaying information from sets of electronically accessible information as augmented reality images. For example, one disclosed embodiment provides a method of presenting information via a computing device comprising a camera and a display. The method includes displaying a representation of each of one or more items of information of a set of electronically accessible items of information. The method further comprises receiving a user input requesting display of a selected item from the set, the selected item comprising a three-dimensional model, obtaining an image of a physical scene, and displaying the image of the physical scene and an image of the selected item together on the display as an augmented reality image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of an augmented reality image comprising a rendering of a three-dimensional model composited with an image of a physical scene.

FIG. 2 shows a block diagram of a system for presenting an augmented reality image according to an embodiment of the present disclosure.

FIG. 3 shows a flow diagram depicting an embodiment of a method of presenting an augmented reality image.

FIGS. 4A-E illustrate an example of a presentation of augmented reality search results according to an embodiment of the present disclosure.

FIGS. 5A-5B illustrate another example of a presentation of an augmented reality image according to an embodiment of the present disclosure.

FIG. 6 shows a block diagram of an embodiment of a computing device.

### DETAILED DESCRIPTION

As mentioned above, different types of items in a set of electronically-accessible information may be presented in different manners, depending upon the type of information that is selected for presentation. For example, image data may be presented in an application such as an Internet browser, while documents, spreadsheets, and the like may be presented via specific applications associated with the type of content selected. Each of these methods of presentation may utilize standard user interface conventions, such as lists, paragraphs of text, 2D/3D visualizations, and graphs, to help a user visualize the displayed information.

In the case of image data, the context in which an image is displayed may provide few visual clues regarding a real-world appearance of an object in the displayed image, as actual scale, surface contour, and other such features of the object may not be clearly evident from the displayed image. This may arise at least partly from the displayed object being presented in the context of a graphical user interface, as graphical user interface features may have little physical correspondence to real-world objects with familiar shapes, sizes and appearances, and thus may provide little real-world context for the image.

Accordingly, embodiments are disclosed herein that relate to the presentation of computer-readable information together with real-world image data as augmented reality images to provide a richer visual contextual experience for the information presented. As one example scenario, a user of a mobile computing device having a camera and a display may perform a search (e.g. an Internet search) for information on an object of interest. Upon performing the search, the search results may include a link to a three-dimensional model of that object. Upon selecting the three-dimensional model for display, the computing device may acquire image data of the physical scene within the field of view of the camera, and also may render an image of the three-dimensional model. The real-world image data and rendered view of the three-dimensional model may then be combined into a single augmented reality image and displayed on a display of the computing device, such as in a camera viewfinder view, thereby allowing the user to visualize the object in relation to the surrounding physical environment.

While various examples are described herein in the context of compositing an image of an object model with an image of a physical scene acquired in real-time, it will be understood that images of object models, and/or any other suitable virtual objects, also may be composited with an image of a physical scene acquired at a different time. In such embodiments, the image of the physical scene may be of a physical scene in which the computing device is currently located, or a different physical scene. The term “augmented reality image” as used herein refers to any image comprising image data of a physical scene (whether acquired in real-time or previously acquired) and also an image of a virtual object, including but not limited to a rendering of an object model as described herein. The term “virtual object” as used herein may refer to any object appearing in an augmented reality image that is not present in the image data of the physical scene and that is combined with the image data of the physical scene to form the augmented reality image, including but not limited to models of objects and images of actual physical objects.

Where dimensional scale information is available for the physical environment and the model, the model may be displayed at a known dimensional scale with reference to the physical environment. This may allow the user to view the rendered model in direct reference to known, familiar real-world objects via a camera viewfinder view, and therefore may provide additional visual context to help the user understand the true appearance of the object represented by the model.

While various examples are described herein in the context of search results, it will be understood that the concepts disclosed herein may be used with any other suitable set of electronically-accessible information. Examples include, but are not limited to, a list of email messages (e.g. an email inbox or folder comprising messages with attachments suitable for presentation in augmented reality images), and a list of files in a storage location (e.g. in a folder or directory viewed via a file system browser). Likewise, while described herein in the context of presenting three dimensional models, it will be understood that any other suitable types of data may be presented. Examples include, but are not limited to, two dimensional models, images, documents, spreadsheets, and presentations.

In some embodiments, a virtual object in an augmented reality image may be presented in a world-locked view relative to a reference object in the physical environment. The term “world-locked” as used herein signifies that the virtual object is displayed as positionally fixed relative to objects in the real-world. This may allow a user to move within the physical environment to view the depicted virtual object from different perspectives, as if the user were walking around a real object. Further, occlusion techniques may be applied so that the depicted virtual object is depicted more realistically. Any suitable reference object or objects may be utilized. Examples include, but are not limited to, geometric planes detected in the physical scene via the image data and objects located via point cloud data of the physical scene, as described in more detail below. It will be understood that a location of a “world-locked” virtual object may be adjusted by a user to reposition the virtual object within the image of the physical scene.

FIG. 1 illustrates an example scenario showing an augmented reality image comprising a virtual object 100 rendered from a three-dimensional model and displayed in a camera viewfinder 102 of a tablet computing device 104. The depicted virtual object 100 takes the form of an image of a whale, and is composited with an image of a user's living room from the perspective of an outward-facing image sensor of the tablet computing device 104 so that the images are displayed together. In the depicted embodiment, physical objects in the image of the physical scene, such as sofa 106, appear in the camera viewfinder 102 in spatial registration and at a similar apparent size with the real-world location of the objects, but it will be understood that a positive or negative magnification also may be applied to the image of the physical scene.

The image of the whale may be positionally fixed relative to a reference object in the room (e.g. the surface of a wall 108), so that the user can move around the virtual object 100 to view it from different angles. Further, metadata 110 related to the virtual object 100 may be displayed to the user. In some instances, the metadata 110 may be displayed as an overlay on a surface in the physical scene such that it appears to be printed on or supported by the surface, while in other instances the metadata 110 may be displayed unconnected to any virtual or physical object, or may be displayed in any other suitable manner. The user also may interact with the virtual object 100 in other ways, such as by scaling it, rotating it, moving it to a different location in the physical scene, etc. In some embodiments, the virtual object may be displayed such that it “snaps to” an object, boundary, geometric plane, or other feature in an image of a physical scene when placed or moved. In other embodiments the virtual object may be placed or moved without any such positional bias relative to physical features in the physical scene, and/or may be moved in any other suitable manner. It will be understood that a user may interact with the virtual object via any suitable user inputs, including but not limited to speech, gesture, touch, and other types of computing device inputs.

In the depicted embodiment, the metadata illustrates example dimensional scale and size information for a real-world whale corresponding to the depicted virtual object. Where dimensional scale information is known for the virtual object and the physical scene, the dimensional scale may have a 1:1 correspondence to the scale of the image of the physical scene, or may have a different known correspondence. In the particular example of FIG. 1, the scale of the virtual object 100 does not correspond 1:1 to the scale of the physical scene, but the depicted metadata 110 provides scale information. In some embodiments, visual scale information may be provided by displaying a virtual representation of a familiar object (e.g. a silhouette, image, avatar, or other likeness of the user) next to the virtual object. In other embodiments, relative scaling of the virtual object and physical scene may be displayed in any other suitable manner.

FIG. 2 shows an example use environment 200 for a system for presenting augmented reality images. Use environment 200 comprises a computing device 202 having a camera 204 and a display 206. The computing device 202 may represent any suitable type of computing device, including but not limited to computing devices in which the camera 204 and display 206 are incorporated into a shared housing and are in fixed relation to one another. Examples of suitable computing devices include, but are not limited to, smart phones, portable media players, tablet computers, laptop computers, and wearable computing devices including but not limited to head-mounted displays. Likewise, the camera 204 may comprise any suitable type or types of cameras. Examples include, but are not limited to, one or more two-dimensional cameras, such as RGB cameras, one or more stereo camera arrangements, and/or one or more depth cameras, such as time-of-flight or structured light depth cameras. The computing device may comprise one or more outward-facing camera that faces away from a user viewing the display 206. Further, in some embodiments, the computing device may include one or more inward facing cameras that face a user viewing the display.

The computing device 202 may communicate with other devices over a network 208. For example, the computing device 202 may communicate with a search engine program 210 running on a search engine server 212 to locate content stored at various content servers, illustrated as content server 1 214 and content server n 216. The content servers 214, 216 may be configured to provide content from content stores, shown respectively as content stores 218 and 220 for content server 1 214 and content server n 216. The content stores may store any suitable type of content, including but not limited to models 222, 224 displayable by the computing device 202 as augmented reality images. The models 222, 224 may include two-dimensional and three-dimensional object models, as well as any other suitable type of content. As mentioned above, the models may include scale information that specifies example physical dimensions of actual objects represented by the models.

Further, the computing device 202 also may communicate with peer computing devices, shown as peer computing device 1 230 and peer computing device n 232. Each peer computing device 230, 232 also may comprise models 234, 236 stored thereon that are displayable by the computing device 202 as augmented reality images. The models 234, 236 stored on the peer computing devices 230, 232 may be obtained by the computing device 202 in any suitable manner. Examples include, but are not limited to, peer-to-peer networking systems, peer-to-peer search engines, email, file transfer protocol (FTP), and/or any other suitable mechanism. Further, models 240 may be stored locally on the computing device 202. It will be understood that FIG. 2 is shown for the purpose of illustration and is not intended to be limiting, as models may be stored at and accessible from any suitable location.

The models may take any suitable form. For example, some models may take the form of three-dimensional scans of real objects. As depth sensing technology progresses, three-dimensional scanners have become less expensive. Further, depth cameras, such as those used as computer input devices, also may be used as three-dimensional scanners. Thus, three-dimensional scans of real objects may become more commonly available as the cost of such scanning technology decreases and the availability increases. Other models may be produced by artists, developers, and such utilizing computer programs for creating/authoring and storing such models, including but not limited to computer-aided design (CAD) and computer-aided manufacturing (CAM) tools, as opposed to being created from scans of real objects. It will be understood that these examples of models and the creation thereof are intended to be illustrative and not limiting in any manner.

FIG. 3 shows a flow diagram depicting an embodiment of a method 300 for presenting search result information as a three-dimensional model, and FIGS. 4A-4E show a non-limiting example scenario illustrative of method 300. Method 300 may comprise, at 302, receiving an input requesting display of a set of electronically-accessible items of information. The request for the display of the set of electronically-accessible items of information may take any suitable form. For example, in some embodiments, the request may take the form of a computer search request, and the set of information may take the form of search results 304. Referring to FIG. 4A, a user is shown entering a search request 400 on a tablet computer 402 to locate information related to the size of a blue whale. In another example, the request may take the form of a request to open an email inbox or other folder, and set of information may take the form of a list of email messages. As yet another example, the request may take the form of a request to view a list of files at a particular location (local or remote), such as at a particular folder or directory, and the set of information may take the form of a displayed list of files. As a further example, the set of information may comprise an electronic catalog of shopping items, and the set of information may comprise a set of links to displayable three-dimensional models of furniture available from the catalog. It will be understood that these examples are intended to be illustrative and not limiting in any manner. Further, in other embodiments, any other suitable event than a user input may be used to trigger a display of a set of electronically accessible information. Examples include, but are not limited to, events detected in environmental sensor data (e.g. motion data, image data, acoustic data), programmatically generated events (e.g. calendar and/or time-related events, computer state-related events), etc.

Method 300 next comprises, at 306, displaying a representation of the set of electronically accessible information, such as search results 308 or other suitable set of information. Referring to the example of FIG. 4B, in response to the user input requesting search results related to the size of a blue whale, various search results are illustrated in different categories, including but not limited to links to images 404, documents 406, videos 408, and also a model 410 displayable as an augmented reality image. In the depicted embodiment, the link to the model 410 includes a user interface icon 411 in the form of a camera that indicates that the model can be opened in the camera viewfinder, but it will be understood that the link may comprise any other suitable appearance.

Continuing with FIG. 3, method 300 comprises, at 310, receiving a user input requesting display of a selected item from the set of electronically accessible items of information, wherein the model is displayable in an augmented reality image. As indicated at 312, the model may be three-dimensional, or may have a two-dimensional appearance (such that the object may not reflect surface contour and shape as richly as a three-dimensional model). Further, as indicated at 314, the model may comprise scale information that reflects a realistic scale of a physical object represented by the model. An example of such a user input is also illustrated in FIG. 4B, where a user selects the link to the model 410 via a touch input.

Upon receiving the user input selecting to view the model, method 300 next comprises, at 316, obtaining an image of a physical scene. In some scenarios, the image may be acquired by utilizing the camera to capture an image of a physical scene. This may comprise, for example, receiving a series of video image frames, such that the image is updated as a user moves through the physical scene. In other embodiments, the image may be previously acquired and retrieved from local or remote storage. In such embodiments, the image may correspond to an image of the physical scene in which the computing device is located, or may correspond to a different physical image.

Further, obtaining the image of the physical scene may comprise, at 318, obtaining an image of an object in the physical scene that comprises a known dimension. Imaging an object of a known dimension may allow scale information for objects in the physical scene to be determined. As one example, a user's hand or foot may have a known dimension when held in a certain posture. Thus, before displaying the model, the user may capture an image frame that includes the user's hand placed near or on an object in the physical scene. Based upon the size of the user's hand in the photo, a scale of the object may be determined, and the scale determined may be used to display the model and the real-world background at a relative scale.

As another example, a known fixed object in the physical scene may be used to determine scale information for the physical scene. For example, referring to FIG. 4C, a user requesting to view a model in an augmented reality image may be asked to direct the camera toward a reference object, which is shown as a picture 420 located on a wall within the physical scene to determine scale information for the physical scene. The user may then select a user interface control (e.g. “GO” button 422) to launch the augmented reality experience.

As yet another example, the physical scene may be pre-mapped via a camera or depth camera to acquire a point cloud representation of the scene that comprises scale information. The use of a fixed object in a scene or a point cloud model to determine scale information for the physical environment may be suitable for physical environments frequently visited by a user (e.g. a room in the user's home), as pre-mapping of the scene may be more convenient in such environments. In contrast, the use of a body part or carried object (e.g. a smart phone or other commonly carried item with a known dimension) for scale information may allow scale to be more conveniently determined for new environments. It will be understood that these example methods for determining scale information for the physical scene are presented for the purpose of example, and are not intended to be limiting in any manner.

Referring again to FIG. 3, method 300 comprises, at 320, displaying the image of the physical scene and a rendered view of the selected item of information together as an augmented reality image. The image may be displayed in any suitable manner. For example, in the case where the computing device on which the augmented reality image will be displayed comprises a smart phone, tablet computer, or other such handheld mobile device, the augmented reality image may be displayed in a camera viewfinder display mode. Likewise, in the case where the computing device comprises a wearable computing device such as a head-mounted display, the augmented reality image may be displayed on a see-through or opaque near-eye display that is positioned in front of the user's eye. In embodiments that utilize a see-through display, the model in some instances may be displayed on the see-through display without being composited with an image from a camera, due to the real-world background being visible through the display. It will be understood that these methods for presenting the augmented reality image are described for the purpose of example and are not intended to be limiting in any manner.

As mentioned above, the model may comprise scale information. Thus, where scale information is known for the model and for the physical scene, method 300 may comprise, at 322, displaying the model and the image of the physical scene at a selected known relative scale. For example, FIG. 4D shows an augmented reality image of a three-dimensional model of a whale 430 displayed as a result of the user selecting the “GO” button 422 of FIG. 4C, and also shows optional dimensional scaling metadata 432. In some instances, a relative scale of the virtual object and the physical scene may be 1:1, such that a user may view the model in a true relative size compared to proximate physical objects. In other instances, any other suitable scaling may be used.

The model may be positioned in the physical environment in any suitable manner. For example, in some embodiments, the model may be displayed in a world-locked relation, such that the model remains stationary as a user moves through the environment. Any suitable method may be used to fix a position of a displayed model relative to a physical scene. For example, in some embodiments, surface tracking techniques may be used to locate surfaces in the environment to use as reference objects for locating the displayed image of the model in the physical scene. As one specific example, rectangle identification may be used to determine surfaces in the environment (e.g. by locating corners of potential rectangular surfaces in image data), and a position of the model may be fixed relative to a detected surface, as shown in FIG. 3 at 326. The location of the surface may then be tracked as a user moves through the environment, and changes in the location and orientation of the surface may be used to reposition (e.g. translate and/or rotate) the model within the displayed image. In other embodiments, a predetermined point cloud of the use environment (e.g. captured via a depth camera) may be used to position and track repositioning of the model within the environment relative to an object identified in the point cloud data, as indicated at 328.

As described above and as indicated at 330, in some instances metadata for the model may be displayed in the augmented reality image along with the image of the model. An example of such metadata is shown in FIG. 4D as dimensional and weight metadata. The metadata may be displayed in any suitable form, including but not limited as displayed on a surface, or separately from any particular surface. Further, in some embodiments a user may reveal or hide the metadata with suitable user inputs.

In some embodiments, metadata or other data related to the displayed model may be obtained via user interaction with the displayed model, or a selected portion thereof, in the augmented reality image. For example, a user may desire more information on the anatomy of a whale's blowhole. As such, the user may zoom the image in on the blowhole of the displayed whale model (e.g. by moving closer to that portion of the model). This may, for example, automatically trigger a display of metadata for that part of the model, allow a user to select to search for more information on the blowhole, or allow a user to obtain information on the blowhole in other ways. The particular portion of the model viewed by the user may be identified based upon metadata associated with the model that identifies specific portions of the model, upon image analysis methods, and/or in any other suitable manner.

Once the augmented reality image is displayed, in some embodiments a user may manipulate the view of the augmented reality image. For example, in embodiments in which the model is world locked, as indicated at 324 in FIG. 3, a user may change a view of the augmented reality image by moving (e.g. walking) within the viewing environment to view the depicted model from different perspectives. Thus, method 300 comprises, at 332, detecting movement of the user in the scene, and at 334, changing the perspective of the augmented reality image based upon the movement. As one example, FIG. 4E shows a view of the model from a closer perspective than that of FIG. 4D resulting from a user moving closer to a location of the model within the physical scene.

FIGS. 5A and 5B show another example embodiment use scenario for displaying an item selected from a set of electronically accessible items together with an image of a physical scene as an augmented reality image. More particularly, these figures show, on a computing device 500, a comparison of a height of a real world physical object (depicted as the Seattle Space Needle) with an image of a virtual model of another physical object (depicted as the Eiffel Tower). To perform the comparison, the user enters a search request for information related to a comparison of the Eiffel Tower, and also enters information related to the Space Needle (e.g. by directing the outward facing camera of the depicted computing device 500 toward the Space Needle to image the Space Needle, by entering information regarding the Space Needle with the Eiffel Tower search query, etc.), as illustrated in FIG. 5A. In other embodiments, a user may utilize a previously-acquired image of the Space Needle.

The search results are depicted as including a link 502 to a model of the Eiffel Tower. Upon selection of this link, the camera viewfinder of the computing device 500 is displayed on the computing device, as illustrated in FIG. 5B, and representations of the virtual Eiffel Tower is displayed at a 1:1 scale next to the view of the Space Needle, thereby giving the user an accurate side-by-side comparison of the two landmarks. The computing device 500 further may display metadata, such as a height of each object or other suitable information.

The computing device 500 may obtain information regarding the physical object in any suitable manner. For example, the user may specify the physical object identity in the search request (e.g. by entering a voice command or making a text entry such as “which is taller—the Eiffel Tower or the Space Needle), by determining the physical object identity through image analysis (e.g. by acquiring an image of the physical object and providing the image to an object identification service), or in any other suitable manner.

Further, a user also may compare two or more virtual objects side by side. For example, a user may perform a computer search asking “what is longer—the Golden Gate Bridge or the Tacoma Narrows Bridge?”, and models representing both bridges may be obtained for scaled display as virtual objects in an augmented reality image.

It will be understood that the above-described use scenarios are intended to be illustrative and not limiting, and that the embodiments disclosed herein may be applied to any other suitable scenario. As another non-limiting example scenario, a person wishing to buy furniture may obtain three-dimensional models of desired pieces of furniture, and display the models as an augmented reality image in the actual room in which the furniture is to be used. A user may then place the virtual furniture object model relative to a reference surface in a room (e.g. a table, a wall, a window) to fix the virtual furniture model in a world-locked augmented reality view in the physical environment of interest. This may allow the user to view the virtual furniture model from various angles to obtain a better feel for how the actual physical furniture would look in that environment.

As mentioned above, in some embodiments the placement of the virtual furniture may be biased by, or otherwise influenced by, locations of one or more physical objects in an image of a physical scene. For example, a virtual couch may snap to a preselected position relative to a physical wall, corner, window, piece of physical furniture (e.g. a table or chair), or other physical feature in the image of the physical scene. In other embodiments, the virtual furniture may be displayed without any bias relative to the location of physical objects, or may be displayed in any other suitable manner.

Further, various colors and textures may be applied to the rendering of the image of the furniture to allow a user to view different fabrics, etc. The augmented reality experience also may allow the user to move the virtual furniture model to different locations in the room (e.g. by unfixing it from one location and fixing it at a different location, either with reference to a same or different reference surface/object) to view different placements of the furniture. In this manner, a user may be provided with richer information regarding furniture of interest than if the user merely has pictures plus stated dimensions of the furniture.

While described above in the context of displaying the augmented reality image with image data obtained via an outward-facing camera, it will be understood that augmented reality images according to the present disclosure also may be presented with image data acquired via a user-facing camera, image data acquired by one or more stationary cameras, and/or any other suitable configuration of cameras and displays.

In some embodiments, the methods and processes described above may be tied to a computing system of one or more computing devices. In particular, such methods and processes may be implemented as a computer-application program or service, an application-programming interface (API), a library, and/or other computer program product.

FIG. 6 schematically shows a non-limiting embodiment of a computing system 600 that can enact one or more of the methods and processes described above. Computing system 600 is shown in simplified form. It will be understood that any suitable computer architecture may be used without departing from the scope of this disclosure. In different embodiments, computing system 600 may take the form of a mainframe computer, server computer, desktop computer, laptop computer, tablet computer, home-entertainment computer, network computing device, gaming device, mobile computing device, mobile communication device (e.g., smart phone), etc.

Computing system 600 includes a logic subsystem 602 and a storage subsystem 604. Computing system 600 further may include a display subsystem 606, input subsystem 608, communication subsystem 610, and/or other components not shown in FIG. 6.

Logic subsystem 602 includes one or more physical devices configured to execute instructions. For example, the logic subsystem 602 may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem 602 may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. Aspects of the logic subsystem may be virtualized and executed by remotely accessible, networked computing devices configured in a cloud-computing configuration.

Storage subsystem 604 includes one or more physical computer-readable memory devices configured to hold data and/or instructions executable by the logic subsystem to implement the methods and processes described herein. When such methods and processes are implemented, the state of storage subsystem 604 may be transformed—e.g., to hold different data.

Storage subsystem 604 may include removable computer-readable memory devices and/or built-in computer-readable memory devices. Storage subsystem 604 may include optical computer-readable memory devices (e.g., CD, DVD, HD-DVD, Blu-Ray Disc, etc.), semiconductor computer-readable memory devices (e.g., RAM, EPROM, EEPROM, etc.) and/or magnetic computer-readable memory devices (e.g., hard-disk drive, floppy-disk drive, tape drive, MRAM, etc.), among others. Storage subsystem 604 may include volatile, nonvolatile, dynamic, static, read/write, read-only, random-access, sequential-access, location-addressable, file-addressable, and/or content-addressable devices. The term “computer-readable memory devices” excludes propagated signals per-se.

In some embodiments, aspects of the instructions described herein may be propagated by a pure signal (e.g., an electromagnetic signal, an optical signal, etc.) via a transmission medium, rather than a computer-readable memory device. Furthermore, data and/or other forms of information pertaining to the present disclosure may be propagated by a pure signal.

In some embodiments, aspects of logic subsystem 602 and of storage subsystem 604 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

The terms “program” and/or “engine” may be used to describe an aspect of computing system 600 implemented to perform a particular function. In some cases, a program or engine may be instantiated via logic subsystem 602 executing instructions held by storage subsystem 604. It will be understood that different programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage subsystem 604. This visual representation may take the form of a graphical user interface (GUI). As the herein described methods and processes change the data held by the storage subsystem, and thus transform the state of the storage subsystem, the state of display subsystem 606 may likewise be transformed to visually represent changes in the underlying data. Display subsystem 606 may include one or more display devices utilizing virtually any type of technology. Such display devices may be combined with logic subsystem 602 and/or storage subsystem 604 in a shared enclosure, or such display devices may be peripheral display devices.

When included, input subsystem 608 may comprise or interface with one or more user-input devices such as a keyboard, mouse, microphone, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a mobile computing device comprising a camera and a display, a method of presenting information, the method comprising:
displaying a representation of each of one or more items of information of a set of electronically accessible items of information;
receiving a user input requesting display of a selected item comprising a three-dimensional model; and
in response to the user input requesting display of the selected item, obtaining an image of a physical scene and displaying the image of the physical scene and an image of the selected item together on the display as an augmented reality image in which a position of the image of the selected item is based upon a reference object in the physical scene.

2. The method of claim 1, wherein displaying the image of the physical scene and the image of the selected item on the display comprises displaying the image of the physical scene and the image of the selected item at a known relative scale to each other as determined via scale information for the physical scene and the scale information for the selected item.

3. The method of claim 2, wherein the image of the physical scene and the image of the selected item are displayed at a 1:1 relative scale.

4. The method of claim 2, wherein the image of the physical scene is obtained from the camera, and further comprising determining a scale of the physical scene by imaging an object comprising a known dimension.

5. The method of claim 1, wherein displaying the image of the physical scene and the image of the selected item as an augmented reality image comprises displaying the image of the selected item in a world-locked relation to the physical scene.

6. The method of claim 5, wherein displaying the image of the selected item in a world-locked relation to the scene comprises displaying the image of the selected item in a fixed location and orientation relative to the reference object.

7. The method of claim 6, wherein the reference object in the scene comprises a surface detected in an image of the scene.

8. The method of claim 6, wherein the reference object comprises a location in a point cloud model of the scene.

9. The method of claim 6, further comprising receiving a user input requesting movement of the image of the selected item, and in response moving the image of the selected item relative to the image of the physical scene.

10. The method of claim 1, wherein the set of information comprises a set of computer search results.

11. The method of claim 1, wherein the computing device comprises one or more of a smart phone, a tablet computing device, and a wearable computing device.

12. The method of claim 1, further comprising displaying metadata related to the selected item.

13. The method of claim 1, further comprising receiving a user input requesting display of the selected item of the set of electronically accessible items of information, wherein the user input requests a comparison of two or more selected items, and wherein displaying the image of the physical scene and the selected item together on the display as an augmented reality image comprises displaying representations of the two or more items at a known relative scale.

14. A mobile computing device comprising:
a camera;
a display;
a logic subsystem; and
a storage subsystem comprising instructions stored thereon that are executable by the logic subsystem to:
display on the display a representation of each of one or more search results of a set of computer search results;
receive a user input requesting display of a selected search result comprising a model with scale information;
in response to the user input requesting display of the selected search result, display the selected search result on the display as an augmented reality image at a selected relative scale to a physical scene in the augmented reality image.

15. The mobile computing device of claim 14, wherein the instructions are executable to display the image of the physical scene and the selected search result on the display by displaying an image of the physical scene and the selected search result at a known relative scale as determined via scale information for the physical scene and the scale information for the selected item.

16. The mobile computing device of claim 15, wherein the instructions are executable to determine scale information for the physical scene by imaging a reference object in the physical scene comprising a known dimension.

17. The mobile computing device of claim 14, wherein the instructions are executable to display the selected item in a world-locked relation to the physical scene.

18. A computer-readable memory device comprising instructions that are executable by a computing device comprising a camera and a display to:
display on the display a representation of each of one or more search results of a set of computer search results;
receive a user input requesting display of a selected search result comprising a three-dimensional model;
in response to the user input requesting display of the selected search result, obtain a three-dimensional model representation of the search result, the three-dimensional model comprising scale information;
obtain via the camera an image of a physical scene, and
display the image of the physical scene and the selected search result together on the display at a selected relative scale as an augmented reality image.

19. The computer-readable memory device of claim 18, wherein the instructions are executable to determine a scale of the physical scene by imaging a reference object comprising a known dimension in the physical scene.

20. The computer-readable memory device of claim 18, wherein the instructions are executable to display the selected search result in a world-locked relation to the physical scene.
